(19) United States
(12) Patent Application Publication
(10) Pub. No.: US 2010/0189954 A1
(43) Pub. Date: Jul. 29, 2010

(54) BUTT JOINT CONNECTIONS FOR CORE MATERIALS

(75) Inventor: Alexander Roth, Griesheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/668,713

(22) PCT Filed: Apr. 15, 2008
(86) PCT No.: PCT/EP08/54539

§ 371 Date: Mar. 16, 2010

(30) Foreign Application Priority Data
Jul. 13, 2007 (DE) 102007033120.9

(51) Int. Cl. B29C 70/06; B32B 5/18; B32B 27/04

(52) U.S. Cl. 428/119

(57) ABSTRACT

The invention is based on the object of improving the mechanical properties of butt joints in sandwich structures via introduction of reinforcement elements in the direction of thickness of the sandwich structure (z direction). The invention can be used for the production of sandwich elements for applications in aerospace, and also in shipbuilding, construction of motor vehicles and of rail vehicles, construction of power-generation systems, and construction of sports equipment.

### FIELD OF THE INVENTION

The invention is based on the object of improving the mechanical properties of butt joints in sandwich structures via introduction of reinforcement elements in the direction of thickness of the sandwich structure (z direction). The invention can be used for the production of sandwich elements for applications in aerospace, and also in shipbuilding, construction of motor vehicles and of rail vehicles, construction of power-generation systems, and construction of sports equipment.

### PRIOR ART

For various applications, polymethacrylimide foams are provided with fibre-reinforced layers, in order to obtain composite materials with excellent properties. These composite materials are used inter alia for the production of rotor blades (U.S. Pat. No. 5,547,629). Bonding to familiar thermoplastics has also been described, an example being lamination of polymethacrylimide foams to polymethyl methacrylate (EP 736 372). Another application of polymethacrylimide foams uses incorporation of conductive particles within the foam, permitting use of the foam for the absorption of electromagnetic radiation (DE 38 264 69 A1). Applications for the automobile industry have also been described (JP 63315229 A2). Other relevant patents are DE 3304882 A, GB 1547978 A, DE 2822881, DE 2235028 and DE 2114524.

### OBJECT

A problem that occurs frequently with the production of components composed of composite materials is that the core materials (foams, for example foams of Rohacell® type, obtainable from Röhm GmbH, or else other foams, for example foams composed of polyvinyl chloride (PVC) or PU) are not available in the dimensions required or desired. By way of example, sections of dimensions about 6 m×5 m would be required for a fin of a modern high-capacity airliner, but foam sheets can only be produced with smaller dimensions, for reasons of manufacturing technology.

Alongside the need to provide core materials with the dimensions demanded, there is a requirement for incorporating, into the composite component, reinforcement suitable for stopping the propagation of cracks within the foam. This is a particularly important function, since the cracks cannot be discerned from outside, because the outer layer is opaque.

In the region of joints, e.g. butt joints (or core junctions), sudden changes in stiffness produce concentrated stresses, which can reduce strength. The adjacent core materials at the joints can be identical or different.

An object was to develop an improved butt joint.

### ACHIEVEMENT OF OBJECT

A butt joint with all of the features of the independent product claim achieves the objects discussed above, and also achieves other objects which, although not individually mentioned, are readily derivable by the person skilled in the art from the discussion in the introduction. Preferred embodiments of the inventive foil are provided by the dependent claims which refer to the independent product claim. The independent process claim protects a process for the production of the inventive joint. The dependent process claims give preferred modifications of the process. The object is achieved in that, within the region of the butt joints of sandwich elements, reinforcement elements are introduced in the direction of the thickness. Different or identical core materials or other materials can be butt-jointed here.

### METHOD OF WORKING THE INVENTION

The reinforcement elements can be introduced (see FIG. 1) in the transition region of the core material with the lower and/or with the higher density or stiffness. Examples of reinforcement elements that can be used are carbon-fibre rods. The reinforcement elements can also penetrate the two outer layers, for example in order to improve delamination properties, impact properties and crack-propagation properties, the result here being that the butt joint and the entire sandwich structure are more tolerant of damage. Possible methods of introducing the reinforcement elements into the core material or sandwich structure use conventional sewing or tufting, pinning by the Aztex principle or the TFC principle as used by Airbus.

The introduction of the reinforcement elements into the core material can firstly reduce the sudden change in stiffness, giving less concentrated stresses, and secondly increases the level of mechanical properties, e.g. tensile properties, compressive properties, shear properties and delamination properties. This favourable effect can raise the static and the cyclic strength of butt joints.

The reinforcement elements can also act as crack stoppers, thus making it possible to prevent unhindered propagation of a crack from one side of the butt joint to the other side.

### Results:

The increase in weight of the component caused by the reinforcement is about 7%, and this can be further reduced by using, for example, ROHACELL® RIMA instead of ROHACELL®WF, thus giving an overall weight saving,
increased static shear strength of about 26%,
increased cyclic shear strength,
longer lifetime.

### Production of Rohacell® Foams

The core layers relevant for the process of the invention comprise poly(meth)acrylimide foam.

Bracketed text is intended to characterize an optional feature. By way of example, (meth)acrylic means acrylic, methacrylic and mixtures composed of both.

The poly(meth)acrylimide foams obtainable from the inventive compositions comprise repeat units that can be represented by formula (I)

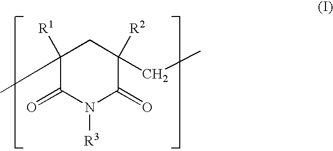

in which
R¹ and R² are identical or different and can be hydrogen or a methyl group, and R³ can be hydrogen or an alkyl or aryl moiety having up to 20 carbon atoms.

Units of the structure (I) preferably form more than 30% by weight, particularly preferably more than 50% by weight, and very particularly preferably more than 80% by weight, of the poly(meth)acrylimide foam.

The production of rigid poly(meth)acrylimide foams is known per se and is disclosed by way of example in GB Patent 1 078 425, GB Patent 1 045 229, DE Patent 1 817 156 (=U.S. Pat. No. 3,627,711) or DE Patent 27 26 259 (=U.S. Pat. No. 4,139,685).

The units of the structural formula (I) can inter alia be formed from adjacent units of (meth)acrylic acid and of (meth)acrylonitrile via a cyclizing isomerization reaction on heating to from 150° C. to 250° C. (cf. DE-C 18 17 156, DE-C 27 26 259, EP-B 146 892). A precursor is usually first produced via polymerization of the monomers in the presence of a free-radical initiator at low temperatures, e.g. from 30° C. to 60° C., with subsequent heating to from 60° C. to 120° C., and this is then foamed (see EP-B 356 714) via a blowing agent present, through heating to from about 180° C. to 250° C.

By way of example, this can be achieved by first forming a copolymer which comprises (meth)acrylic acid and (meth)acrylonitrile, preferably in a molar ratio of from 1:3 to 3:1.

These copolymers can moreover comprise other monomer units, for example those derived from esters of acrylic or methacrylic acid, in particular with lower alcohols having from 1 to 4 carbon atoms, e.g. methanol, ethanol, propanol, isopropanol, n-butanol, isobutanol or tert-butanol, or derived from styrene and styrene derivatives, such as α-methylstyrene, or derived from maleic acid or its anhydride, itaconic acid or its anhydride, or derived from vinylpyrrolidone, vinyl chloride or vinylidene chloride. The proportion of the comonomers which cannot be cyclized or can be cyclized only with major difficulty is not to exceed 30% by weight, preferably 20% by weight and particularly preferably 10% by weight, based on the weight of the monomers.

Other monomers that can be used advantageously in a manner likewise known are small amounts of crosslinking agents, e.g. allyl acrylate, allyl methacrylate, ethylene glycol diacrylate or ethylene glycol dimeth-acrylate, or polyvalent metal salts of acrylic or methacrylic acid, e.g. magnesium methacrylate. The quantitative proportions of these crosslinking agents are frequently in the range from 0.005% by weight to 5% by weight, based on the total amount of polymerizable monomers.

Metal salt additions can moreover be used and often reduce smoke level. Among these are inter alia the acrylates or methacrylates of the alkali metals or of the alkaline earth metals or of zinc, of zirconium or of lead. Preference is given to Na (meth)acrylate, K (meth)acrylate, Zn (meth)acrylate and Ca (meth)-acrylate. Amounts of from 2 to 5 parts by weight of the monomers markedly reduce smoke density in the FAR 25.853a fire test.

Polymerization initiators used comprise those conventional per se for the polymerization of (meth)-acrylates, examples being azo compounds, such as azodiisobutyronitrile, and also peroxides, such as dibenzoyl peroxide or dilauroyl peroxide, or else other peroxide compounds, such as tert-butyl peroctanoate or perketals, and also, if appropriate, redox initiators (in which connection cf. by way of example H. Rauch-Puntigam, Th. Völker, Acryl- and Methacrylverbindungen [Acrylic and methacrylic compounds], Springer, Heidelberg, 1967, or Kirk-Othmer, Encyclopedia of Chemical Technology, Vol. 1, pages 286 et seq., John Wiley & Sons, New York, 1978). The amounts preferably used of the polymerization initiators are from 0.01 to 0.3 by weight, based on the starting materials.

It can also be advantageous to combine polymerization initiators with various decomposition properties with respect to time and temperature. By way of example, simultaneous use of tert-butyl perpivalate, tert-butyl perbenzoate and tert-butyl 2-ethylperhexanoate or of tert-butyl perbenzoate, 2,2-azobisiso-2,4-dimethyl-valeronitrile, 2,2-azobisisobutyronitrile and di-tert-butyl peroxide is very suitable.

The polymerization reaction preferably takes place by way of variants of bulk polymerization, an example being that known as the cell process, but is not restricted thereto.

The weight-average molar mass M̅_{w} of the polymers is preferably greater than 10⁶ g/mol, in particular greater than 3×10⁶ g/mol, but with no intended resultant restriction.

For the foaming of the copolymer during conversion to a polymer containing imide groups, blowing agents are used in a known manner and form a gas phase at from 150° C. to 250° C., via decomposition or vaporization.

The decomposition of blowing agents having amide structure, e.g. urea, or monomethyl- or N,N′-dimethylurea, or formamide or monomethylformamide, liberate ammonia or amines, which can contribute to additional formation of imide groups. However, it is also possible to use nitrogen-free blowing agents, such as formic acid, water, or monohydric aliphatic alcohols having from 3 to 8 carbon atoms, e.g. 1-propanol, 2-propanol, n-butan-1-ol, n-butan-2-ol, isobutan-1-ol, isobutan-2-ol, pentanols and/or hexanols. The amount used of blowing agent depends on the desired density of the foam, but the amounts used of the blowing agents here in the reaction mixture are usually from about 0.5% by weight to 15% by weight, based on the monomers used.

The precursors can moreover comprise conventional additives. Among these are inter alia antistatic agents, antioxidants, mould-release agents, lubricants, dyes, flame retardants, flow improvers, fillers, light stabilizers and organic phosphorus compounds, such as phosphites or phosphonates, pigments, weathering stabilizers and plasticizers.

Conductive particles which inhibit electrostatic charging of the foams are another class of preferred additives. Among these are inter alia metal particles and carbon black particles, both of which can also be present in the form of fibres whose size is in the range from 10 nm to 10 mm, as described in EP 0 356 714 A1.

The following steps can by way of example give a polymethacrylimide foam whose use is very particularly preferred:
1. Production of a polymer sheet via free-radical polymerization of a composition composed of
   (a) a monomer mixture composed of 20% by weight to 60% by weight of methacrylonitrile, from 80% by weight to 40% by weight of methacrylic acid and, if appropriate, up to 20%, based on the entirety of methacrylic acid and methacrylonitrile, of other monofunctional monomers having vinylic unsaturation
   (b) from 0.5% by weight to 15% by weight of a blowing agent mixture composed of formamide or monomethylformamide and of a monohydric aliphatic alcohol having from 3 to 8 carbon atoms in the molecule
   (c) a crosslinking agent system which is composed of
      (c.1) from 0.005% by weight to 5% by weight of a compound having vinylic unsaturation and having at least 2 double bonds in the molecule and capable of free-radical polymerization and
      (c.2) from 1% by weight to 5% by weight of magnesium oxide dissolved in the monomer mixture
   (d) an initiator system
   (e) conventional additives.
2. This mixture is polymerized for a number of days at from 30° C. to 45° C. in a cell formed from two glass plates of size 50*50 cm and an edge seal of thickness 2.2 cm. The polymer is then subjected to a heat-conditioning programme ranging from 40° C. to 130° C. for about 20 h, for completion of polymethacrylimide polymerization. The subsequent foaming takes place during a few hours at from 200° C. to 250° C.

Polymethacrylimides with high heat resistance can moreover be obtained by reaction of polymethyl methacrylate or its copolymers with primary amines, which can likewise be used according to the invention. Of the wide variety of examples of this polymer-analogous imidation reaction, the following may be mentioned as representative: U.S. Pat. No. 4,246,374, EP 216 505 A2, EP 860 821. High heat resistance can be achieved here either via use of arylamines (JP 05222119 A2) or via the use of specific comonomers (EP 561 230 A2, EP 577 002 A1). However, all of these reactions give solid polymers rather than foams, and if a foam is to be obtained these have to be foamed in a separate second step. Techniques for this are also known to persons skilled in the art.

Rigid poly(meth)acrylimide foams can also be obtained commercially, an example being Rohacell® from Röhm GmbH, which can be supplied in various densities and sizes.

The density of the poly(meth)acrylimide foam is preferably in the range from 20 kg/m³ to 320 kg/m³, particularly preferably in the range from 50 kg/m³ to 110 kg/m³.

With no intended resultant restriction, the thickness of the core layer is in the range from 1 mm to 200 mm, in particular in the range from 5 mm to 100 mm and very particularly preferably in the range from 10 mm to 70 mm.

The core layer can also have other layers in the interior. However, in the process of the present invention a poly(meth)acrylimide foam is connected to a fibre-reinforced layer. In particular embodiments of the inventive process, however, a core layer is used which is composed of poly(meth)acrylimide foam.

The fibre-reinforced layer used can comprise any known sheet-like structure which is stable under the processing conditions, such as pressure and temperature, needed for the production of composite materials. Webs which have a multilayer structure can also be used as fibre-reinforced layer.

Among these are inter alia, by way of example, fibre-reinforced foils in which polypropylene, polyester, polyamide, polyurethane, polyvinyl chloride and/or polymethyl (meth)acrylate is present.

The fibre-reinforced layer can also be obtained via curing of known resins comprising fibres, examples being epoxy resins (EP resins), methacrylate resins (MA resins), unsaturated polyester resins (UP resins), phenolic resins, isocyanate resins, bismaleimide resins and phenacrylate resins (PHA resins).

Fibre reinforcement that can be used is inter alia carbon fibres, glass fibres, aramid fibres, polypropylene fibres, polyester fibres, polyamide fibres, polyurethane fibres, polymethyl (meth)acrylate fibres, polyvinyl chloride fibres and/or metal fibres.

It is also possible and preferable to use, by way of example, prepregs, among which are also SMCs (sheet moulding compounds), in order to obtain a fibre-reinforced layer on the core layer. SMC and prepregs are webs preimpregnated with curable plastics, mostly being glass-fibre mats, glass-filament wovens, or rovings comprising carbon fibres and/or comprising aramid fibres, which can be hot-press processed to give mouldings or semifinished products. Among the SMCs that can be used are in particular SMCR (SMC with randomly oriented fibres), SMCO (SMC with oriented fibres), SMCCR (SMC with fibres oriented to some extent), XMC (SMC with network-like fibre reinforcement) and HMC (SMC with high fibre content).

These materials are known per se and are described by way of example in Ullmann's Encyclopedia of Industrial Chemistry, 5th edition, under the heading “Fabrication of Polymer Composites”).

Alongside a fibre-reinforced layer, it is also possible to connect layers composed of metal via the process of the present invention particularly securely to the core layer. Among these are inter alia thin foils or sheets composed of aluminium. To produce a composite material, the metal layer can be used alone or together with a fibre-reinforced layer. Particularly preferred metal layers are inter alia the materials known as aluminium prepregs.

The connection of the core layer to the fibre-reinforced layer or to the metal layer after the treatment with the organic solvent is dependent on the type of layer to be applied. Appropriate processes are known per se.

By way of example, composite materials which comprise a core comprised of poly(meth)acrylimide foam and a fibre-reinforced layer or a metal layer can generally be obtained by what are known as hot-press processes. These processes are well known to persons skilled in the art, and the invention here also encompasses specific embodiments such as twin-belt presses, SMC presses and GMT presses.

For further strengthening of the composite material, the core layer can be compacted during the hot-pressing process. For this, spacers, known as stops, can be used during the press procedure. These make it easier to set a desired degree of compaction of the core layer, but there is no intention of any resultant restriction of the invention.

To improve adhesion, an adhesive can also be used, which can be applied after treatment of the surface with the organic solvent. However, for some materials of the fibre-reinforced layer this is not necessary.

By way of example, for production of the composite material, an amount of an SMC layer or of a prepreg layer, where the amount is appropriate for the weight, can be laid on the appropriately dimensioned foam sheet within a mould and subjected to pressure from a press.

Typical conditions under which the prepregs or SMCs begin to flow and to cure are pressures of more than 1 N/mm² and temperatures in the range from 60° C. to 180° C. These parameters can also be used in graduated stages in order to avoid accumulation of heat. The press time is usually from 5 minutes to 6 hours, as a function of the fibre-reinforced layer. One particularly advantageous range is from 10 to 120 minutes.

The abovementioned resins and fibre reinforcement can also be applied manually to the poly(meth)acrylimide foam. Here, resin layers and fibre webs are laid alternately. After the fibre-reinforced resin layer has been applied, the resin is cured in a known manner. Appropriate systems can be obtained by way of example with the name West System, from M.u.H. von der Linden GmbH, P.O. Box 100543, D-46465 Wesel/Rhein, Germany.

The thickness of the outer layer is preferably in the range from 0.1 to 100 mm, with preference in the range from 0.5 to 50 mm and very particularly preferably in the range from 1 to 5 mm.

### EXPLANATION OF THE FIGURES AND KEY

FIG. 1 shows the structure of a reinforced joint.

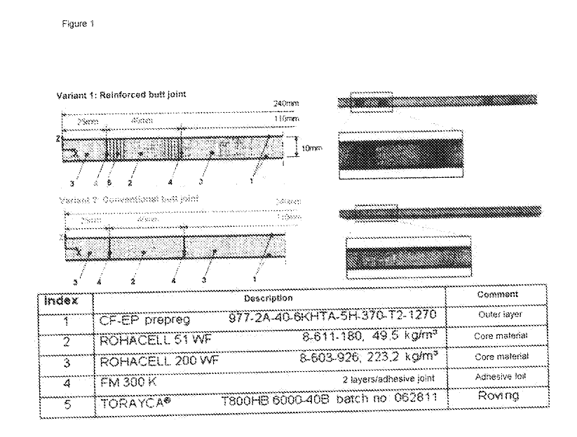

FIG. 2 shows the usual forces and modes of failure for non-reinforced butt joints.

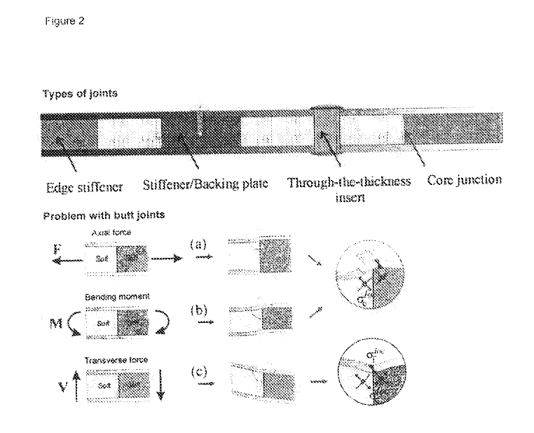

FIG. 3 shows the improvement by virtue of the inventive reinforcement of the butt joints.

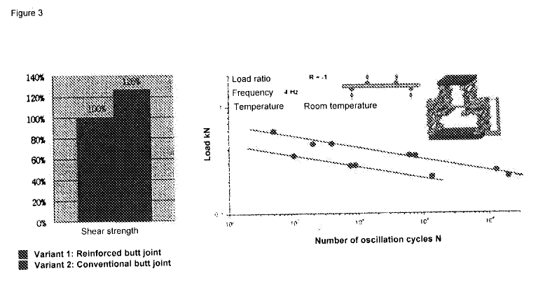

The inventive reinforcement can be used in the construction of spacecraft, in which particular importance is placed on joints which are light but stable, and also in the construction of aircraft, in particular of high-capacity passenger aircraft or of high-capacity freighter aircraft, or in the construction of ships or of hydrofoils or of hovercraft, and in the construction of land vehicles, for example in the construction of rail vehicles. Another advantageous application of the inventive use of the improved butt joint is the construction of blades of wind turbines.

1. An improved butt joint of identical or different core materials in sandwich structures,
wherein
one or more reinforcement elements is/are introduced within a region adjacent to the butt joint to be improved within the core materials.

2. The improved butt joint according to claim 1,
wherein
Rohacell® foams are used as core materials.

3. The improved butt joint according to claim 1,
wherein
carbon-fibre-material parts are used as reinforcement elements.

4. A spacecraft, aircraft, watercraft or land vehicle comprising the improved butt joint according to claim 1.

5. A wind turbine comprising the improved butt joint according to claim 1.

6. An equipment for sports comprising the improved butt joint according to claim 1.
